(19) United States
(12) Patent Application Publication
(10) Pub. No.: US 2024/0198333 A1
(43) Pub. Date: Jun. 20, 2024

(54) SYSTEMS, APPARATUS AND METHODS FOR EXTRACTING AND ANALYSING CELLULAR MATERIAL

(71) Applicant: University of South-Eastern Norway, Porsgrunn (NO)

(72) Inventors: Frank Karlsen, Klokkarstua (NO); Lars Roseng; Henrik Jakobsen, Tønsberg (NO)

(21) Appl. No.: 18/286,876

(22) PCT Filed: Apr. 4, 2022
(86) PCT No.: PCT/EP2022/058869

§ 371 Date: Oct. 13, 2023

(30) Foreign Application Priority Data
Apr. 14, 2021 (GB) 2105293.1

(51) Int. Cl. B01L 3/00

(52) U.S. Cl. CPC B01L 3/50273; B01L 3/502738; B01L 2200/025; B01L 2200/027; B01L 2200/0647; B01L 2200/10; B01L 2200/16; B01L 2400/043; B01L 2400/0487; B01L 2400/049; B01L 2400/06

(57) ABSTRACT

Systems, methods and apparatus for extracting and analysing cellular material utilizing an integrated lab-on-a-chip (LOG) (1) and an instrument (2). The instrument (2) comprises an interface (4) for holding the LOG, one or more valve actuators or vacuum system (5), a detection unit (6) and one or more pumps (7). The LOG comprises a loading chamber (L), an extraction chamber (21), a reaction unit (22), and one or more valves (V1-V10). The extraction chamber (21) comprises one or more gas ports (37, 38) that are configured to be placed in fluid communication with the one or more pumps (7) to enable the generation of positive and negative pressures in the extraction chamber (21) to enable pumping of fluid into and out of the extraction chamber (21).

The present disclosure relates to systems, apparatus and methods for extracting and analyzing cellular material. In a non-limiting example the disclosure relates to extracting, purifying, quantifying, amplifying and detecting nucleic acids. For example, it relates to a system comprising a lab-on-a-chip and an associated instrument.

### BACKGROUND TO THE DISCLOSURE

Integrated lab-on-a-chip diagnostic systems for carrying out a sample preparation process on a fluid sample containing cells and/or particles are known. One example is described in WO2005/073691 wherein an integrated lab-on-a-chip diagnostic system is described that comprises: (a) an inlet for a fluid sample; (b) a lysis unit for lysis of cells and/or particles contained in the fluid sample; (c) a nucleic acid extraction unit for extraction of nucleic acids from the cells and/or particles contained in the fluid sample; (d) a reservoir containing a lysis fluid; and (e) a reservoir containing an eluent for removing nucleic acids collected in the nucleic acid extraction unit. The sample inlet is in fluid communication with the lysis unit, an optional valve being present to control the flow of fluid therebetween. The lysis unit is in fluid communication with the nucleic acid extraction unit, an optional valve being present to control the flow of fluid therebetween. The reservoir containing the lysis fluid is in fluid communication with the lysis unit, an optional valve being present to control the flow of fluid therebetween. The reservoir containing the eluent is in fluid communication with the nucleic acid extraction unit, an optional valve being present to control the flow of fluid therebetween.

There is a desire to develop and improve integrated lab-on-a-chip diagnostic systems.

### SUMMARY OF THE DISCLOSURE

In a first aspect the present disclosure provides a system for extracting and analysing cellular material, the system comprising an integrated lab-on-a-chip and an instrument;

the instrument comprising:
a) an interface for holding the integrated lab-on-a-chip;
b) one or more valve actuators or vacuum system for actuating one or more valves of the integrated lab-on-a-chip;
c) a detection unit for detecting an output of a reaction unit of the integrated lab-on-a-chip; and
d) one or more pumps;
   the integrated lab-on-a-chip comprising:
i) a loading chamber having an inlet for receiving a mixture comprising a sample containing cells and/or particles and a lysis buffer;
ii) an extraction chamber;
iii) a reaction unit; and
iv) one or more valves that control flow of fluid;
the loading chamber and the reaction unit being selectively enabled to be in fluid communication with the extraction chamber by actuation of the one or more valves of the integrated lab-on-a-chip as enabled by operation of the one or more valve actuators or vacuum system of the diagnostic instrument;
wherein the extraction chamber comprises or is connected to one or more gas ports that are configured to be placed in fluid communication with the one or more pumps of the instrument such that operation of the one of more pumps enables the generation of positive and negative pressures in the extraction chamber to enable pumping of fluid into and out of the extraction chamber.

In a second aspect the present disclosure provides an integrated lab-on-a-chip comprising:
i) a loading chamber having an inlet for receiving a mixture comprising a sample containing cells and/or particles and a lysis buffer;
ii) an extraction chamber;
iii) a reaction unit; and
iv) one or more valves that control flow of fluid;
the loading chamber and the reaction unit being selectively enabled to be in fluid communication with the extraction chamber by actuation of the one or more valves of the integrated lab-on-a-chip;
wherein the extraction chamber comprises or is connected to one or more gas ports that are configured to be placed in fluid communication with one or more external pumps such that operation of the one of more external pumps enables the generation of positive and negative pressures in the extraction chamber to enable pumping of fluid into and out of the extraction chamber.

In a third aspect the present disclosure provides a method of extracting and analysing cellular material using an integrated lab-on-a-chip and a diagnostic instrument, the method comprising the steps of:
i) loading a mixture comprising a sample containing cells and/or particles and a lysis buffer into a loading chamber of the integrated lab-on-a-chip;
ii) transporting the mixture from the loading chamber to an extraction chamber of the integrated lab-on-a-chip;
iii) mixing the mixture in the extraction chamber using a plurality of beads to lyse the cells and/or particles of the sample and bind cellular material of the cells and/or particles to the beads;
iv) optionally transporting excess liquid from the extraction chamber to waste;
v) transporting a wash buffer from a wash chamber of the integrated lab-on-a-chip to the extraction chamber;
vi) washing the beads and their bound cellular material with the wash buffer in the extraction chamber;
vii) optionally transporting excess liquid from the extraction chamber to waste;
viii) transporting an elution buffer from an elution chamber of the integrated lab-on-a-chip to the extraction chamber;
ix) eluting the beads and their bound cellular material with the elusion buffer in the extraction chamber to detach the cellular material from the beads to form an eluate containing the cellular material; and
x) transporting the eluate to a reaction unit of the integrated lab-on-a-chip, optionally amplifying the cellular material in the reaction unit, and analysing the cellular material using the instrument;
wherein the transportation of fluid into and/or out of the extraction chamber is carried out by generating positive and negative pressures in the extraction chamber by use of one or more pumps that are in fluid communication with the extraction chamber.

In a fourth aspect the present disclosure provides an instrument for actuating an integrated lab-on-a-chip, the instrument comprising:
a) an interface for holding the integrated lab-on-a-chip;
b) one or more valve actuators or vacuum system for actuating one or more valves of the integrated lab-on-a-chip;
c) a detection unit for detecting an output of a reaction unit of the integrated lab-on-a-chip;
d) one or more pumps; and
e) a magnetic actuator for moving magnetic beads in an extraction chamber of the integrated lab-on-a-chip.

The systems, methods, integrated lab-on-a-chips (LOCs) and instruments of the present disclosure may beneficially enable multi-stage processing and analysis of cellular material on the same LOC. They may find particular benefit in extracting and analysing nucleic acids. They may allow extraction, purification, amplification and detection of nucleic acids to be performed on a single LOC. They may permit the direct quantification of extracted RNA and/or DNA in combination with calibrator related isothermal amplification and detection making it possible to perform quantification or absolute quantification of RNA or DNA within biological samples.

The systems, methods, integrated lab-on-a-chips (LOCs) and instruments of the present disclosure may beneficially enable preparation of purified RNA/DNA or both for further sequence analysis using different kinds of normal, conventional, field, point-of-need, point-of-care, or at-home sequencing equipment.

One or more of the above-described aspects may also comprise one or more of the following optional features:

The one or more gas ports may comprise a negative pressure port and a positive pressure port.

The one or more pumps may comprise a positive pressure pump connected to a positive pressure port of the extraction chamber and a negative pressure pump connected to a negative pressure port of the extraction chamber.

The one or more pumps may be motor-operated, preferably stepper-motor operated.

The extraction chamber may have a volume for treating ≥0.75 millilitre, preferably ≥1.0 millilitre of the mixture.

At least one of the gas ports may be directly connected to the extraction chamber, preferably to a top side of the extraction chamber.

At least one of the gas ports may be indirectly connected to the extraction chamber, preferably via a microfluidic channel.

The integrated lab-on-a-chip may further comprise a waste reservoir, the waste reservoir being selectively enabled to be in fluid communication with the extraction chamber by actuation of the one or more valves of the integrated lab-on-a-chip.

The integrated lab-on-a-chip may further comprise a first waste microchannel and second waste microchannel for transporting liquid to the waste reservoir along at least two waste paths.

The waste reservoir may have a volume of ≥20 ml, preferably ≥30 ml.

The extraction chamber may comprise a plurality of beads, preferably magnetic beads.

The instrument may further comprise a magnetic actuator for moving magnetic beads in the extraction chamber.

The magnetic actuator may be movable to alter a separation distance between the magnetic actuator and the extraction chamber when the integrated lab-on-a-chip is held by the interface.

The magnetic actuator may be movable towards and away from the extraction chamber, along an axis that is perpendicular to a plane of the integrated lab-on-a-chip.

The magnetic actuator may be rotatable for inducing a jumping movement of the magnetic beads in the extraction chamber.

The magnetic actuator may comprise an array of magnets, and preferably the magnets may be arranged in a cross-shaped array.

The integrated lab-on-a-chip may further comprise a wash chamber containing a wash buffer, the wash chamber being selectively enabled to be in fluid communication with the extraction chamber by actuation of the one or more valves of the integrated lab-on-a-chip.

The integrated lab-on-a-chip may further comprise a second wash chamber containing a second wash buffer, wherein the second wash chamber is selectively enabled to be in fluid communication with the extraction chamber by actuation of the one or more valves of the integrated lab-on-a-chip.

The integrated lab-on-a-chip may further comprise an elution chamber containing an elution buffer, the elution chamber being selectively enabled to be in fluid communication with the extraction chamber by actuation of the one or more valves of the integrated lab-on-a-chip.

The integrated lab-on-a-chip may further comprise a reagent chamber containing reagent that is selectively enabled to be in fluid communication with the extraction chamber by actuation of the one or more valves of the integrated lab-on-a-chip.

The reaction unit may contain additional reagent, preferably lyophilized reagent.

The integrated lab-on-a-chip may further comprise a conduit, preferably a microchannel, communicating between the extraction chamber and the reaction unit, and the conduit may contain or pass through a quantification chamber configured to enable direct quantification of cellular material, for example nucleic acids, passing towards the reaction unit.

The quantification chamber may comprise a wall transmissive to radiation, preferably in the 260-280 nm range, and the instrument may comprise a detector for detecting radiation emitted from the quantification chamber.

The system may be for extracting, amplifying and detecting nucleic acids.

The reaction unit of the integrated lab-on-a-chip may be a nucleic acid reaction unit, preferably a nucleic acid sequence amplification and detection unit.

The cellular material may be nucleic acids.

The transportation of fluids into the extraction chamber may be carried out by generating a negative pressure in the extraction chamber by use of one or more pumps and the transportation of fluids out of the extraction chamber may be carried out by generating a positive pressure in the extraction chamber by use of one or more pumps.

The sample may be filtrated before the mixture is loaded into the loading chamber

In step iii) of the third aspect the plurality of beads may be magnetic and the mixing may comprise moving an external magnet or array of magnets to move the magnetic beads in the extraction chamber.

Part of step iii), of the third aspect may comprise transporting the mixture from the extraction chamber back to the loading chamber and then back to the extraction chamber by generating positive and negative pressures in the extraction chamber. The beads in the extraction chamber may be magnetic beads and may be moved using the external magnet or array of magnets during transport of the mixture from the extraction chamber back to the loading chamber and then back to the extraction chamber.

In step ix) of the third aspect during elution the beads may be held to a base of the extraction chamber by an external magnet or array of magnets.

After step vii) of the third aspect, the method may comprise transporting a second wash buffer from a wash chamber, preferably a second wash chamber, to the extraction chamber, and washing the beads and their bound cellular material with the second wash buffer in the extraction chamber, and transporting excess liquid from the extraction chamber to waste.

Steps viii) and ix) of the third aspect may comprise two elution stages:
a first elution stage in which a first quantum of the elution buffer may be transported from the elution chamber to the extraction chamber and flushed through the extraction chamber to waste to remove impurities from the extraction chamber; and
a second elution stage in which a second quantum of the elution buffer may be transported from the elution chamber to the extraction chamber and held for a retention period in the extraction chamber to detach the cellular material from the beads to form an eluate containing the cellular material.

Between steps ix) and x) of the third aspect the method may comprise transporting reagent from a reagent chamber of the integrated lab-on-a-chip to the extraction chamber for mixing with the eluate.

In step x) of the third aspect additional reagent may be mixed with the eluate in the reaction unit.

In step x) of the third aspect the method may further comprise directly quantifying the cellular material, for example nucleic acids, as they are transported to the reaction unit, preferably by radiometric quantification.

### BRIEF DESCRIPTION OF THE DRAWINGS

Aspects and embodiments of the present disclosure will now be described, by way of example only, with reference to the accompanying drawings, in which:

FIG. 1 is a perspective view of an instrument of the present disclosure;

FIG. 2 shows a portion of the instrument of FIG. 1;

FIG. 3 is a perspective view of an integrated lab-on-a-chip (LOC) of the present disclosure;

FIG. 4 shows an exploded view of the LOC of FIG. 3;

FIG. 5 shows a chip layer of the LOC of FIG. 3;

FIG. 6 shows a base layer of the LOC of FIG. 3;

FIG. 7 shows an upper housing of the LOC of FIG. 3;

FIG. 8 shows an interior view of a portion of the LOC of FIG. 3;

FIG. 9 shows an exterior view of a portion of the LOC of FIG. 3;

FIG. 10 shows a waste reservoir of the LOC of FIG. 3;

FIG. 11 shows a valve of the LOC of FIG. 3;

FIG. 12 shows a cross-sectional view of the valve of FIG. 11;

FIGS. 13A to 13H illustrate schematically fluid flows in the base layer of the LOC of FIG. 3;

FIG. 14 is a graph of results from NASBA for two targets;

### DETAILED DESCRIPTION

The skilled reader will recognise that one or more features of one aspect or embodiment of the present disclosure may be combined with one or more features of any other aspect or embodiment of the present disclosure unless the immediate context teaches otherwise.

In one aspect the present disclosure relates to a system for extracting and analyzing cellular material. In the present specification “cellular material” refers to material obtained from lysis of cells (whole cells and/or cell particles) and may include, for example, proteins, lipids, carbohydrates and nucleic acids.

In the following non-limiting example(s) the system will be described in relation to extracting, amplifying and detecting nucleic acids.

The system comprises an integrated lab-on-a-chip (LOC) 1 and an instrument 2.

The system may be, for example, a total analysis system capable of performing DNA/RNA extraction, purification, and separation and detection of specific nucleic acids. The system may enable the detection, autonomous processing, and analysis of specific nucleic acids from any random DNA/RNA sample. For example, the system can be used to identify multiple DNA/RNA targets, for example up to 32 different DNA/RNA targets, in a sample.

The system may be used, for example, as a point-of-care system wherein the analysis of the cellular material, e.g. nucleic acids, is performed at or near to the site of a patient with the result leading to a potential change in the care of that patient. Alternatively, the system may be used, for example, for analysis of cellular material remote from the patient, e.g. in a laboratory.

In another aspect the present disclosure relates to an instrument 2 that may be used, for example, in the above described system and may form, for example, a point-of-care instrument.

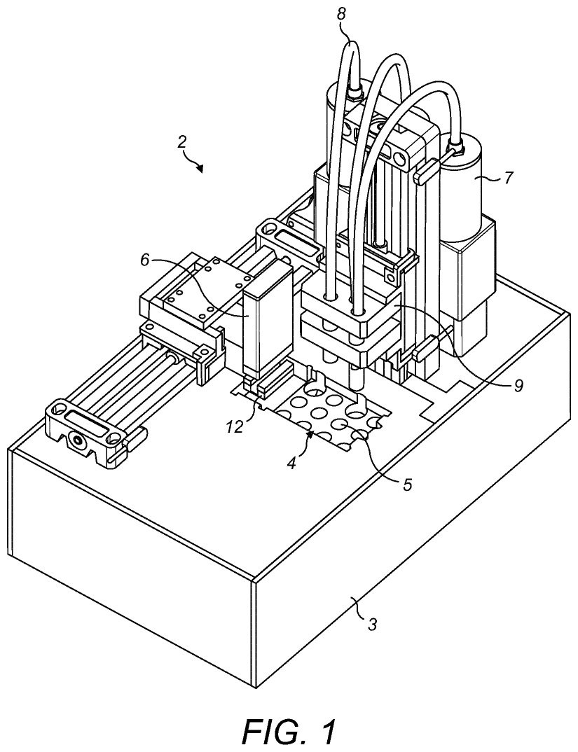

An example of the instrument 2 is shown in FIG. 1.

The instrument 2 may comprise:
an interface for holding the LOC 1;
one or more valve actuators 5 or vacuum system for actuating one or more valves of the LOC 1;
a detection unit 6 for detecting an output of a reaction unit 22 of the LOC 1; and
one or more pumps 7 that may be used to actuate valves of the LOC 1.

The interface for holding the LOC 1 may preferably stabilize the LOC1 so as to maintain a controlled and constant positioning of the LOC 1 relative to the instrument 2. A vacuum system may be used in place of the one or more valve actuators 5 for actuating the one or more valves of the LOC 1. The components of the instrument 2 may be contained in a housing 3. The housing 3 may contain a power supply for the instrument 2 or means to connect the instrument 2 to an external power supply.

The instrument 2 may comprise a controller for controlling some or all functions of the components of the instrument 2. In this specification the term “controller” refers to a function that may comprise hardware and/or software. The controller may comprise a control unit or may be a computer program running on a dedicated or shared computing resource. The controller may comprise a single unit or may be composed of a plurality of sub-units that are operatively connected. The controller may be located on one processing resource or may be distributed across spatially separate processing resources. The controller may comprise a microcontroller, one or more processors (such as one or more microprocessors), memory, configurable logic, firmware, etc. The controller may be provided in the housing 3 of the instrument 2 or external to the housing 3. The controller may function in combination with one or more remote controllers external to the instrument 2. For example, an on-board microcontroller may control functions of the instrument 2 under instruction from an external computer.

The interface for holding the LOC 1 may comprise a recess 4 that may be sized and shaped to receive and hold the LOC 1. The recess 4 is preferably open at its top to allow the LOC 1 to be placed or slotted into position. Placement of the LOC 1 into and out of the recess 4 may be carried out manually or by other means, for example by a robotic manipulator arm.

The one or more valve actuators 5 may be associated with a bottom of the recess 4 as shown in FIG. 1. For example, 10 valve actuators 5 may be provided. Each valve actuator 5 may comprise an actuator port, for example a cylindrical hole defined by a cylindrical tube, for receiving a valve of the LOC 1. Each actuator port may have an associated coil of an electromagnet. Energisation of the coil with electricity, for example at a potential of 3V, may be used to move vertically up and down a valve of the LOC 1 received in the actuator port as will be described further below. The controller may control operation of the valves of the LOC 1 by control of the coils of the valve actuators 5. Multiple valve actuators 5 may be operated simultaneously. For example, a microcontroller may be provided with four or more serial interface units for controlling four or more valve actuators 5 simultaneously.

In other embodiments the valve actuators 5 may have an alternative design. The valve actuators 5 may be any suitable actuator for selectively operating the valves of the LOC 1. For example, the valve actuators may operate the valves using a negative or positive fluid pressure (gas or liquid) rather than using electromagnetic actuation. For example, a vacuum pump may be provided as part of a vacuum actuation system that may be configured to operate the valves of the LOC 1.

The detection unit may comprise an optical detector 6. For example, the optical detector 6 may be a fluorescence measurement system. The fluorescence measurement system may use a confocal measurement principle. One example of a suitable system is the ESE log system available from Qiagen, of Manchester, UK. The system works by using impinging light based on a confocal measurement principle. In confocal systems the excitation and emission beam have the same, parallel course. In the detector, the measurement signal is extracted by a precise system of beam splitters and filters. Use of a confocal system may be beneficial compared to an off-axis system since the positioning of the sample to be detected is less critical with a confocal system.

The optical detector 6 may be mobile in x, y, z, space relative to the recess 4. For example, the optical detector 6 may be provided in an optical unit that is mounted to the housing 3 using one or more rails and step engines. A horizontal step engine may be provided to provide precise and controlled movement in the x, y dimensions. A vertical step engine may be provided to provide precise and controlled movement in the z dimension. The step engine may move the optical detector 6, as directed by the controller, to any position above the recess 4 for detecting emissions from reactions chambers of a LOC 1 held in the recess 4 as will be described further below. The optical detector 6 is enabled to be located at an exact position, in order to ensure that the light focus is within the middle area of each reaction chamber of the LOC 1, by the step engines.

The one or more pumps 7 may comprise two or more pumps 7. It is preferred that two, or at least two pumps 7 are provided. One pump may function as a vacuum pump, i.e. for creating a negative pressure. One pump may function as a pressure pump, i.e. for creating a positive pressure. Each pump 7 may function at different times as a vacuum pump and a pressure pump. A third pump may optionally be provided. The third pump may function as a backup pump, for example as either or both a vacuum pump or a pressure pump.

Each pump 7 may be connectable to the LOC 1 in use. For example, each pump 7 may comprise a syringe pump (or other pressure vessel and a stepper motor. The stepper motor may be controlled by a stepper motor driver that may be part of, or controlled by the controller. The stepper motor may control movement of a piston of the syringe pump in precise increments. The stepper motor may enable the piston to be moved in forwards and reverse directions to produce pressure and suction from the same syringe pump. For example, each pump's range of movement may be from 0 to 45 steps, and the pump may be set to a reference point of the 30th step. To create pressure, the pump may move forward from the 30th step, and to create a vacuum, the pump may move backward from the 30th step or vice versa.

For example, each syringe pump may have a working volume of 60 ml able to generate up to 140 kPa of positive or negative pressure inside a connected chamber of the LOC 1.

Each pump 7 may be connected to the LOC 1 by a hose 8. The hose 8 may be flexible. The hose 8 may be polymeric or rubber tubing. A distal end of each tube may be configured in its shape and size, e.g. internal diameter, to be connected to a gas port of the LOC 1 as will be described further below. The distal end of each tube may be mobile in the z dimension relative to the recess 4 to enable the hoses 8 to be connected and disconnected from the gas ports of the LOC 1. For example, the distal ends of the hoses 8 may be mounted to a holder 9 that is movable in the z dimension along a rail by means of a stepper motor.

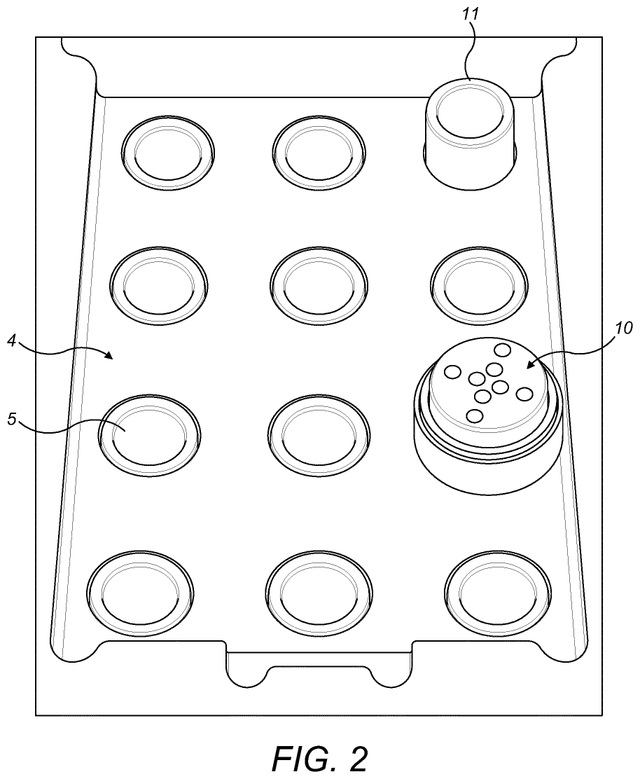

The instrument 2 may further comprise a magnetic actuator 10. In some examples, the magnetic actuator may be in the form of a magnetic spinner. The magnetic actuator 10 may be associated with a bottom of the recess 4 as shown in FIG. 1. The magnetic actuator 10 may comprise one or more magnets that are rotatable relative to an extraction chamber 21 of the LOC 1. The one or more magnets may be permanent magnets or electromagnets. A plurality of magnets may be provided. Eight magnets may be provided. The magnets may be arranged in a cross-shaped pattern as shown in FIG. 2. Two magnets may be provided in the direction of each point of the compass, N, E, S, W. The magnets may be rotatable about a centre point of the cross-shaped pattern. The magnets may be rotated in one sense or may be rotatable forward and back in both senses, e.g. clockwise and counter-clockwise, for example by an amount of up to 5/10/15 degrees.

The magnetic actuator 10 is preferably movable to alter a separation distance between the magnetic actuator 10 and the extraction chamber of the LOC 1 when the LOC 1 is held by the interface. For example, the magnetic actuator 10 may be movable towards and away from the extraction chamber. The magnetic actuator 10 may be movable along an axis that is perpendicular to a plane of the LOC 1. For example, the magnetic actuator 10 may be movable in the z dimension, for example towards and away from the LOC 1 when it is held in the recess 4.

The magnetic actuator 10 may function, and in particular may be rotatable, so as to induce a jumping movement of magnetic beads contained in the extraction chamber of the LOC 1. The magnetic actuator 10 may additionally function to selectively restrain movement of magnetic beads within the extraction chamber. For example, in a first mode the magnetic actuator 10 may be moved towards the extraction chamber to a point where the magnetic flux of the magnets engages the magnetic beads. The magnetic actuator 10 may then be rotated or spun in one rotational sense or rotated back-and-forth in both rotational senses to induce movement of the magnetic beads. In a second mode the magnetic actuator 10 may be moved closer to the extraction chamber than in the first mode such that the magnetic flux of the magnets engages the magnetic beads and hold the beads against a base of the extraction chamber. In this second mode the magnetic actuator 10 is preferably not rotated. In a third mode the magnetic actuator 10 may be moved further away from the extraction chamber than in the first mode such that the magnetic flux of the magnets does not interact (or substantially interact) with the magnetic beads in the extraction chamber.

The instrument 2 may further comprise a video camera 11 whose camera lens is associated with the recess 4. In particular, the lens may be orientated to face upwards to detect movement of nucleic acids within the LOC 1 as will be described further below. Additionally or alternatively to the video camera 11, the instrument 2 may be comprise a detector for detecting radiation, for example radiation in the non visual part of the spectrum, for example in the 260-280 nm range.

The instrument 2 may further comprise one or more heaters 12 associated with the recess 4. Two heaters 12 may be provided. Each heater may comprise a heating block. Each heater may be a silicon thick film heater operated by a resistor heating element and an electronic control board. The heaters 12 may be adjustable from air or room temperature up to 100° C.

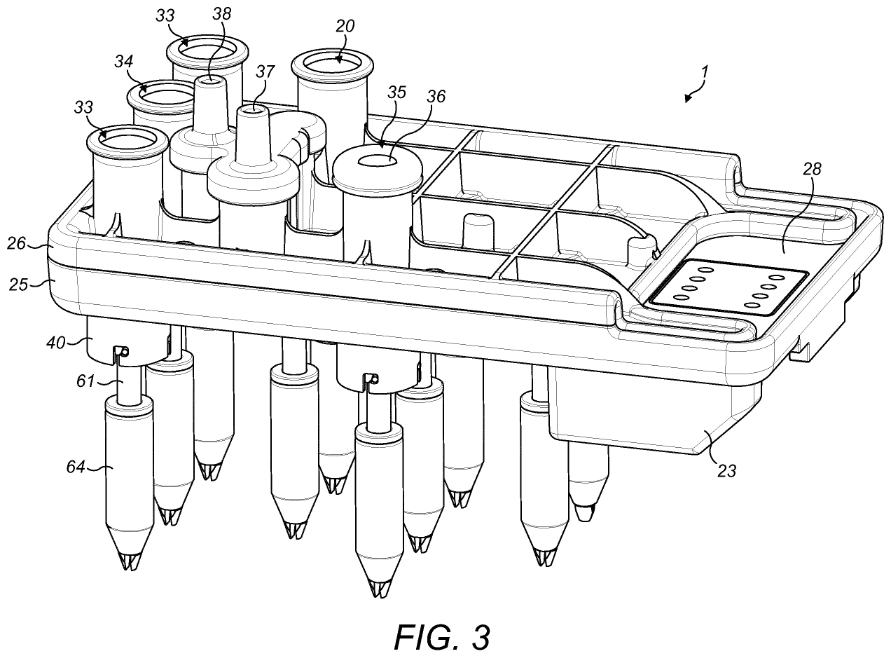

In another aspect the present disclosure relates to an integrated lab-on-a-chip (LOC 1) that may be used, for example, with the above described instrument 2 as part of the above described system. An example of the LOC 1 is shown in FIG. 3.

The LOC 1 may comprise:
a loading chamber L having an inlet 20 for receiving a mixture comprising a sample containing cellular material, e.g. cells and/or particles containing nucleic acids, and a lysis buffer;
one or more wash chambers W1, W2 containing wash buffer;
an elution chamber E containing an elution buffer;
a reagent chamber R containing reagent;
an extraction chamber 21;
a reaction unit 22, for example a nucleic acid reaction unit, e.g. a nucleic acid sequence amplification and detection unit;
a waste reservoir 23; and
one or more valves that control flow of fluid.

The chambers and other components of the LOC 1 may be provided in the form of a cassette as shown in FIG. 3. The cassette may be a single-use, disposable cassette.

The cassette may be fabricated by, for example, injection moulding of a plastic material, e.g. COC plastic, CNC milling of a plastic material, e.g. COP plastic, or 3D printing of a suitable material.

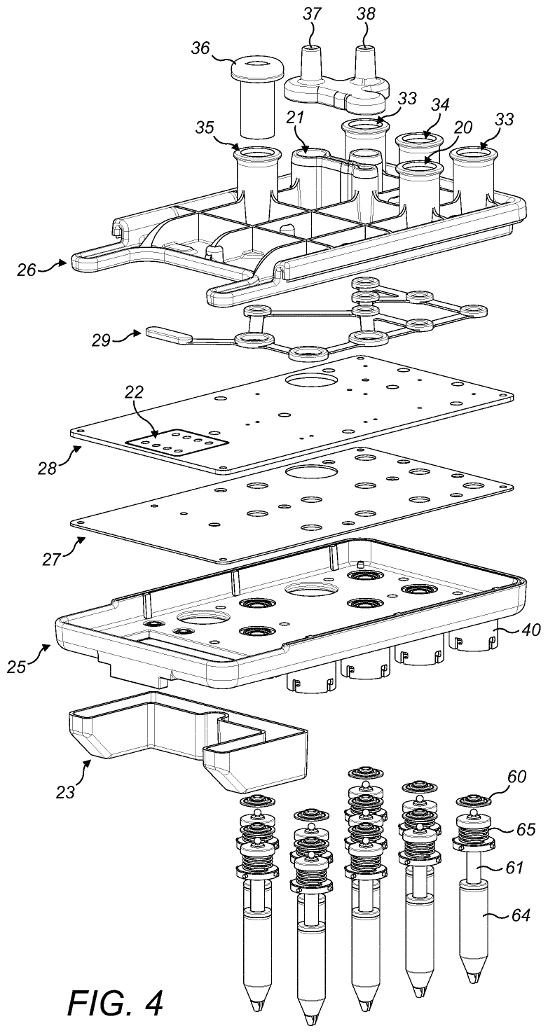

The cassette may comprise a lower housing 25 and an upper housing 26 that contain a base layer 27, a chip layer 28 and a gasket 29, as shown in FIG. 4. The waste reservoir 23, as shown in FIG. 10, may form part of the lower housing 25 or be a separate part coupled to the lower housing 25.

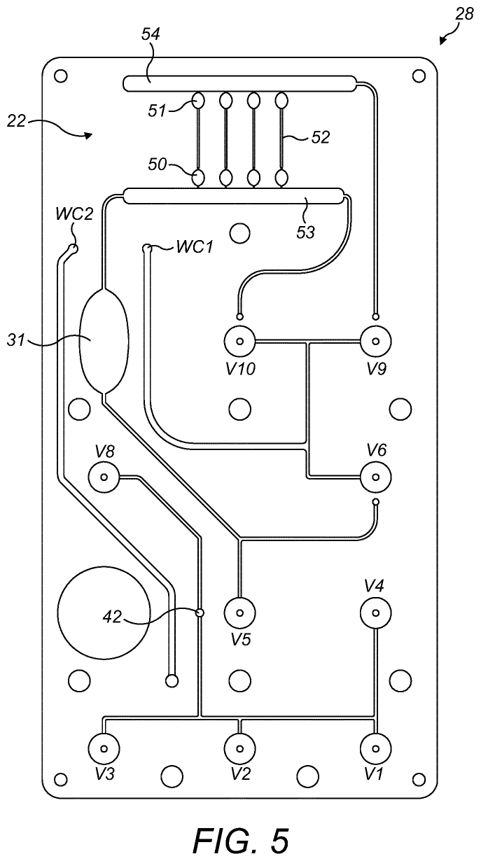

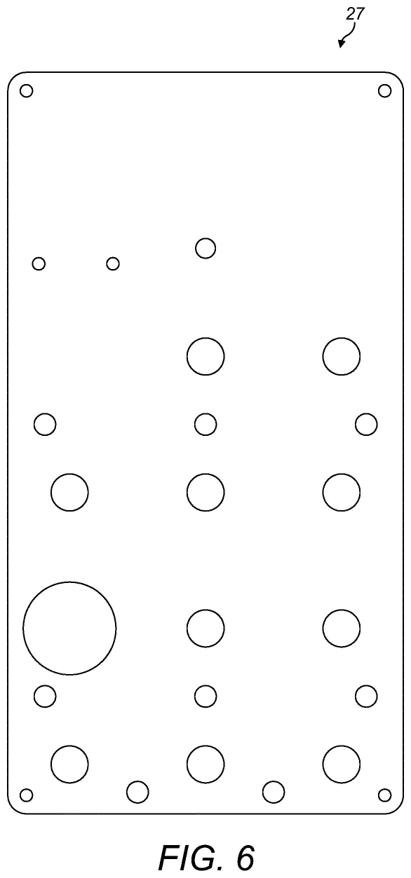

The chip layer 28, shown in FIG. 5, together with the base layer 27, shown in FIG. 6, may define a plurality of channels, for example microfluidic channels for transporting fluid around the LOC 1. The microfluidic channels may be formed in a lower face of the chip layer 28. The base layer 27 may form a bottom wall of the microfluidic channels.

The microfluidic channels may comprise two channel sizes—0.5 mm*0.5 mm in cross-section or 1.0 mm*1.0 mm in cross-section. The 0.5 mm*0.5 mm sized channels may be used for transfer of liquids and the 1.0 mm*1.0 mm sized channels may be used for creating positive and negative pressures in the LOC 1, in particular in the extraction chamber 21.

In addition the chip layer 28 together with the base layer 27 may define the reaction unit 22. The chip layer 28 may be relatively compact at a size of approximately 120 mm by 65 mm by 1.3 mm.

The chip layer 28 may be provided with a quantification chamber 31 configured to enable direct quantification of cellular material, e.g. nucleic acids, passing towards the reaction unit 22. The quantification chamber 31 may be an eye-shaped chamber formed as a portion of a channel leading to the reaction unit 22. The quantification chamber 31 may comprise a wall, for example a bottom wall, that is transmissive to radiation, for example visible light or radiation in the 260-280 nm range.

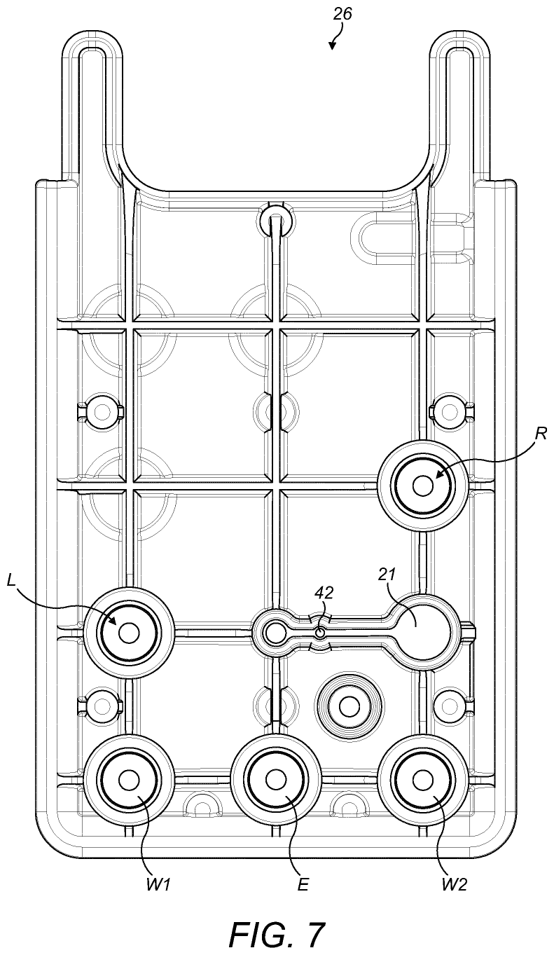

The upper housing 26 may define together with the chip layer 28 the loading chamber L, the one or more wash chambers W1, W2, the elution chamber E and the extraction chamber 21, as shown in FIG. 7. The upper housing 26 may also define a loading chamber inlet 20, one or more wash chamber inlets 33, an elution chamber inlet 34 and a reagent chamber inlet 35. Each inlet may be closed by a removable cap 36. The upper housing 26 may also define one or more gas ports. There may be provided a first gas port 37 and a second gas port 38.

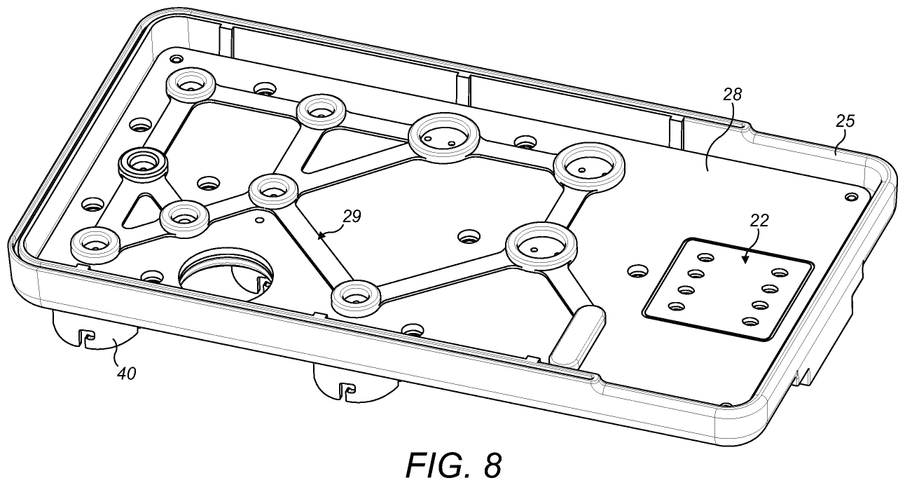

The gasket 29, as shown in FIG. 8, may provide fluid-sealing between the upper housing 26 and an upper face of the chip layer 28, i.e. the face of the chip lay opposite the face comprising the channels forming the microfluidic channels 30. The chip layer 28 may be bonded to the base layer 27. The chip layer 28 may be bonded to the base layer 27 in FIG. 5 using ultrasound welding, exact glue exposure or preferably using programmable laser bonding using a suitable welder, e.g. a Powerweld 2000 or 2600 available from LPKF Laser & Electronics AG, of Garbsen, Germany. This process creates the overall chip structure of the LOC 1.

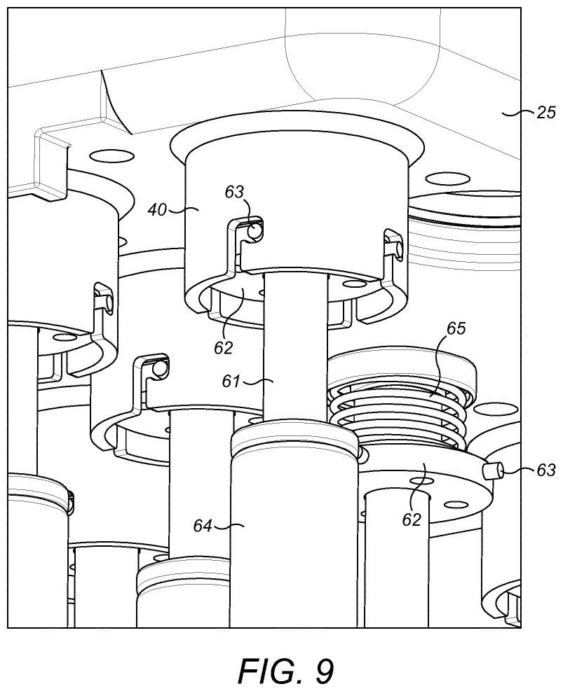

The lower housing 25 may define a plurality of tubular mounts 40, as shown in FIG. 9, for mounting of the valves. Each tubular mount 40 may comprise a bore that receives a valve. A bayonet mechanism may be provided for retaining the valve in the bore.

The loading chamber L may hold, for example, up to 1.5 ml of a mixture. The mixture may comprise a sample comprising cellular material, e.g. cells and/or particles containing cellular material in the form of nucleic acids (e.g. DNA/RNA), and a lysis buffer. Preferably the mixture and/or sample is filtrated before being added to the LOC 1. The mixture may be loaded into the loading chamber L by uncapping the loading chamber inlet 20 and syringing the mixture into the loading chamber L. The loading chamber inlet 20 may then be recapped.

Two wash chambers may be provided, a first wash chamber W1 and a second wash chamber W2. Each wash chamber W1, W2 may contain, for example, approximately 0.5 to 2.5 ml of wash buffer. The wash buffer may be preloaded into the wash chambers W1, W2 through the wash chamber inlets 33. The first wash buffer of wash chamber W1 may comprise, for example, of 96% ethanol. The second wash buffer of wash chamber W2 may comprise, for example, of 70% ethanol.

The elution chamber E may have, for example, a volume of 400 microliter containing an elution buffer. The elution buffer may be preloaded into the elution chamber E through the elution chamber inlet 34. The elution buffer may comprise of RNase free water or RNase free 0.01 mM Tris-HCl buffer.

The reagent chamber R may be preloaded with reagent. The reagent may, for example, be suitable for amplification and/or detection of nucleic acids. For example, the reagents may be added to the purified RNA and/or DNA in order to perform isothermal amplification and detection of nucleic acids using, for example, a Nucleic Acid Sequence Based Amplification (NASBA), or any other isothermal amplification technique, including but not limited to loop-mediated isothermal amplification (LAMP), whole genome amplification (WGA), strand displacement amplification (SDA), helicase-dependent amplification (HAD), recombinase polymerase amplification (RPA). The reagents may be used, for example, to prepare the RNA and DNA for downstream whole genome point-of-care sequencing. The reagent in the reagent chamber R may comprise, for example, of KCL, DMSOL and/or Sorbitol. In some examples the reagent chamber R may contain only the Blue oligonucleotides, KCL, DMSOL, and Sorbitol whereas the Red enzymes, probes, and primers may be stored in the reaction unit 22, preferably in a lyophilized form. The reagents may be preloaded into the reagent chamber R through the reagent chamber inlet 35.

The extraction chamber 21 may have, for example, a volume of 1000 μl or more. The extraction chamber 21 may contain a plurality of beads. Preferably the beads are magnetic heterogeneous beads. In some examples the beads as silica magnetic beads. The total volume of the beads may be provided in a volume of 50 μl mixed with RNAse free glycerol. Each bead may be spherical or a randomly-shaped bead. Each bead may have a diameter of 10 nanometer to 500 micrometer.

The extraction chamber 21 may have a circular pattern at its base. This structure may help to make the silica magnetic beads jump around the reaction chamber during the magnetic mixing, which may increase the possibility of binding of the cellular material, e.g. DNA/RNA, with the surface of the beads.

The first gas port 37 and the second gas port 38 may be in fluid communication with the extraction chamber 21. One or both gas ports may be directly or indirectly connected with the extraction chamber 21. The first gas port 37 may be connected to a top side of the extraction chamber 21. The first gas port 37 may be aligned directly above the extraction chamber 21. The second gas port 38 may be connected to the extraction chamber 21 via a microfluidic opening that opens into the extraction chamber 21.

The chip layer 28 may be provided with a transfer port 42 that fluidly connects the extraction chamber 21 in the upper housing 26 with the chip layer 28. In use fluid from the loading chamber L, the first wash chamber W1, the second wash chamber W2, the elution chamber E and the reagent chamber R may be pumped to the extraction chamber 21 along one or more microchannels of the chip layer 28 to the transfer port 42, then through the transfer port 42 into a transfer conduit 43 of the upper housing 26, as shown in FIG. 7, that communicates with the extraction chamber 21.

The waste reservoir 23 may be located below the reaction unit 22. The waste reservoir 23 may, for example, have a volume of 30 ml or greater. The relatively large volume of the waste reservoir 23 may ensure that the chamber is not overfilled. The waste reservoir 23 may also be used for creating a negative pressure inside the extraction chamber 21. Two microchannels WC1 and WC2 may communicate with the waste reservoir 23 to avoid collision between pure and impure samples during the process.

The reaction unit 22, for example a nucleic acid reaction unit, may comprise a plurality or reaction wells. The reaction wells may be grouped into a first set of reaction wells 50 and a second set of reaction wells 51. The sets of reaction wells may be interconnected by microfluidic channels 52. Each set may comprise, for example, 8 or more reaction wells. The reaction wells may each have a volume of, for example, 3 μl.

The reaction unit 22 may comprise a first supply channel 53 that connects an input to the reaction unit 22 with the first set of reaction wells 50. The input may be a conduit, e.g. a microfluidic channel, fluidly connected to an output from the extraction chamber 21, for example a conduit that leads from the extraction chamber 21 to the reaction unit 22 via the quantification or validation chamber 31.

The reaction unit 22 may further comprise a second supply channel 54 that connects the second set of reaction wells 51 with a conduit leading to the waste reservoir 23.

In other embodiments the first supply channel 53 or the second supply channel 54 may also communicate with an outlet of the LOC 1 for supplying fluid, e.g. containing extracted and purified and optionally amplified cellular material, e.g. nucleic acids, to an external device. The external device may be for example a device or instrument or apparatus for testing, analyzing or carrying out further processing of the cellular material. In one example, the external device may be an apparatus for performing whole genome sequencing of nucleic acids (e.g. a nanopore sequencing instrument).

The first set of reaction wells 50 may, for example, contain reagent for the amplification and detection process. The reagent may contain NASBA buffer, MgCl2, dNTPs and primer-sets and probes. The reagent may be lyophilized. The reagent may be in the form of lyophilized beads. The reagent may be stored in the first set of reaction wells 50 associated with the first supply channel 53. The reagent in the first set of reaction wells 50 may comprise primer and probes. Every time a molecular beacon probe finds an amplified synthesized target it binds to it and release photons.

The second set of reaction wells 51 may also contain reagent. These wells may contain the NASBA red enzymes like Reverse Transcriptase, RnaseH and T7 RNA polymerase.

The valves are used to control flow of fluid within the LOC 1. In the examples illustrated the LOC 1 comprises nine valves. The locations of the valves are shown in FIG. 5. The functions of the valves are as follows:
Valve V1—control of flow into/out of the first wash chamber W1.
Valve V2—control of flow into/out of the elution chamber E.
Valve V3—control of flow into/out of the second wash chamber W2.
Valve V4—control of flow into/out of the loading chamber L.
Valve V5—control of flow into/out of the extraction chamber 21.
Valve V6—control of flow into/out of the waste reservoir 23.
Valve V8—control of flow into/out of the reagent chamber R.
Valve V9—control of flow into/out of the waste reservoir 23 and reaction unit 22.
Valve V10—control of flow into/out of the waste reservoir 23 and reaction unit 22.

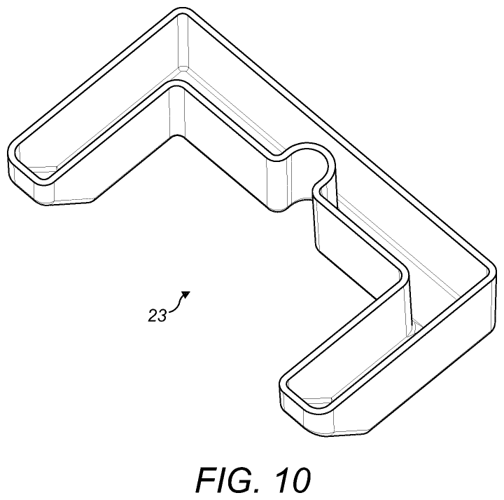

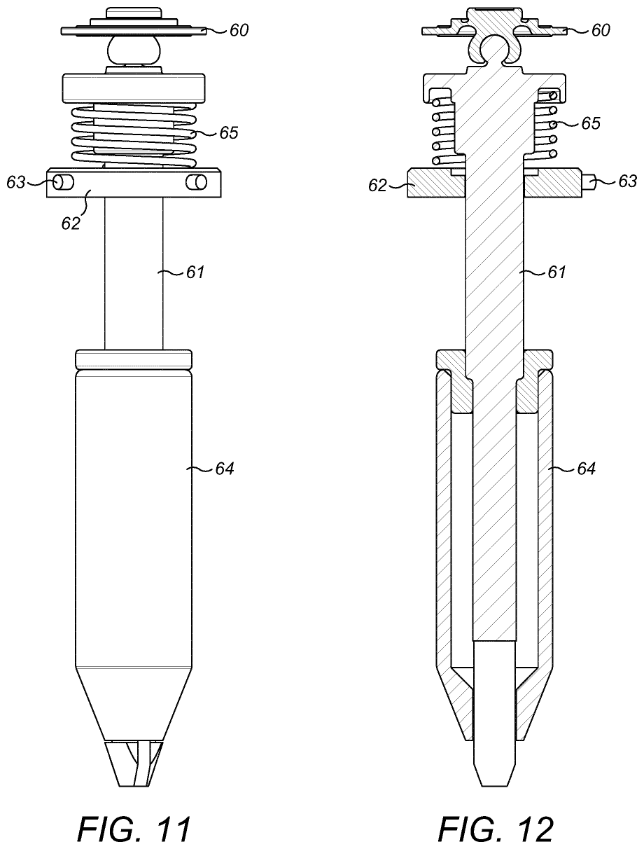

An example of one of the valves is shown in FIGS. 11 and 12. The valve may comprise a valve button 60 mounted on an upper end of a valve rod 61. The valve rod 61 may have an associated collar 62 with one or more projections 63 that act as a bayonet fitting for coupling the valve to the tubular mount 40 of the lower housing 25. A lower end of the valve rod 61 is connected to a metal cylinder 64 that in use may be electromagnetically-coupled to the coil of the instrument 2 to move the valve rod 61, and the mounted valve button 60 up and down. The valve may also comprise a spring 65 mounted around the valve rod 61 to bias the valve into an open or closed configuration. The valve button 60 may be formed from silicone. The valve rod 61 may be plastic. The metal cylinder 64 may be steel.

In use, a mixture comprising a sample containing cellular material, e.g. cells and/or particles containing nucleic acids, and a lysis buffer may first be loaded into the loading chamber L via the loading chamber inlet 20.

The LOC 1 may then be inserted into the instrument 2, in particular inserted into the recess 4 of the instrument 2. On insertion each valve of the LOC 1 may be received in an actuator 5 of the instrument 2. In particular, at least the metal cylinder 64 of the valve may be inserted into the actuator 5 so as to extend through the coil of the actuator.

In addition, the extraction chamber 21 of the LOC 1 may be positioned directly above the location of the magnetic actuator 10 of the instrument 2. In addition, the first and second sets of reaction wells 50, 51 may be positioned directly above, respectively, the first heater and the second heater of the instrument 2. In addition, the quantification chamber 31 of the LOC 1 may be positioned directly above the video camera 11 or other detector of the instrument 2.

In use, the loading chamber L, the wash chamber, the elution chamber E, the reaction unit 22 and the waste reservoir 23 may be selectively enabled to be in fluid communication with the extraction chamber 21 by actuation of the one or more valves of the LOC 1 as enabled by operation of the one or more valve actuators 5 of the instrument 2.

In particular, the one or more gas ports 37, 38 may be configured to be placed in fluid communication with the one or more pumps 7 of the instrument 2 such that operation of the one of more pumps 7 enables the generation of positive and negative pressures in the extraction chamber 21 to enable pumping of fluid into and out of the extraction chamber 21. Preferably, the fluid connection is such as to ensure that liquid from the LOC 1 never enters or contacts the one or more pumps 7. For example, the gas ports 37, 38 may each be provided with an aerosol filter to prevent liquid being passed from the LOC 1 into the pumps 7. With the use of the pumps 7, fluid may be brought into the extraction chamber 21 by creating a negative pressure in the extraction chamber 21, and fluid in the extraction chamber 21 may be transported out of the extraction chamber 21 by creating a positive pressure inside the extraction chamber 21.

There follows a description of an example process using the instrument 2 and LOC 1 of the system. By way of example only the process described is for the extraction of cellular material in the form of nucleic acids from cells and/or particles using a Boom extraction technique, purification/enrichment/separation of the extracted nucleic acids and subsequent amplification and detection of extracted RNA/DNA. Beneficially all parts of the process are carried out with the cellular material remaining in the same LOC.

A first pump 7 may be fluidly connected to the first gas port 37 that is located directly above the extraction chamber 21. A second pump 7 may be fluidly connected to the second gas port 38. The pumps 7 may be connected to the gas ports 37, 38 by operating the stepper motor to lower the holder 9 carrying the distal ends of the hoses 8 to engage the hoses 8 onto the gas ports. The set points of the pistons of the pumps 7 may be calibrated at one or more steps of the process, for example when first engaging the hoses 8 to the gas ports.

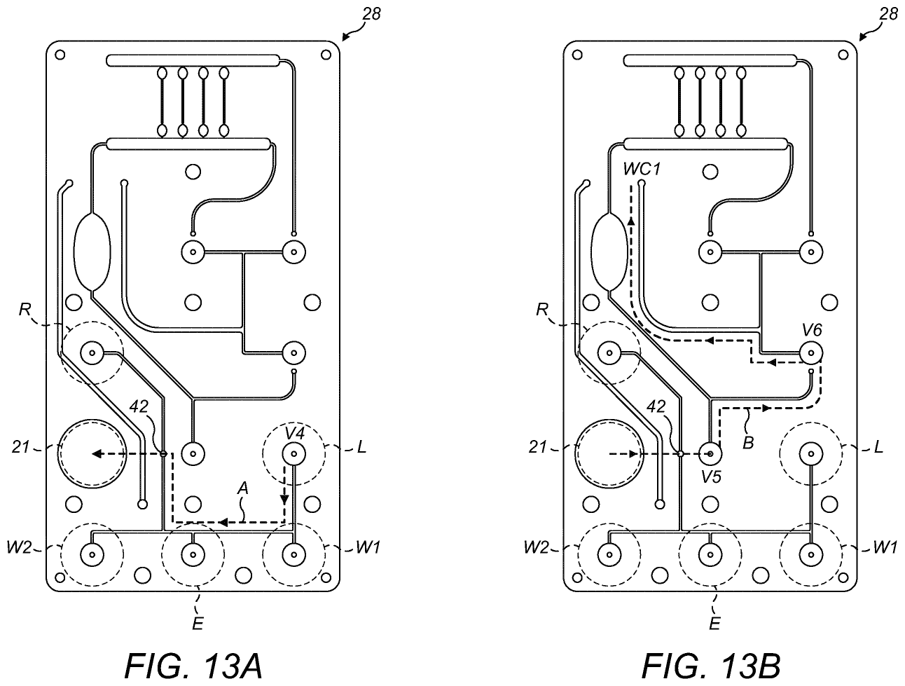

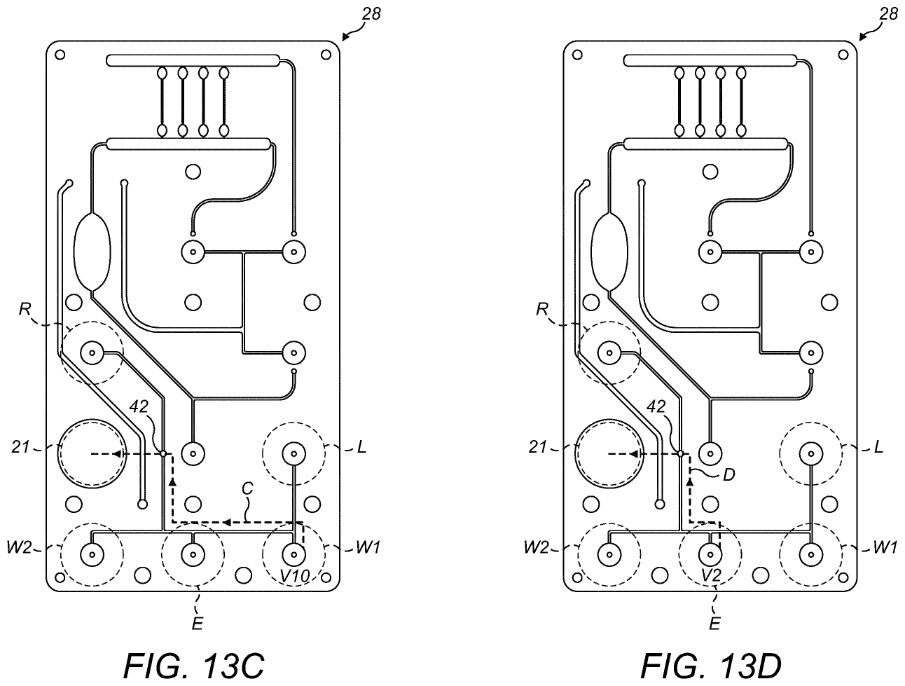

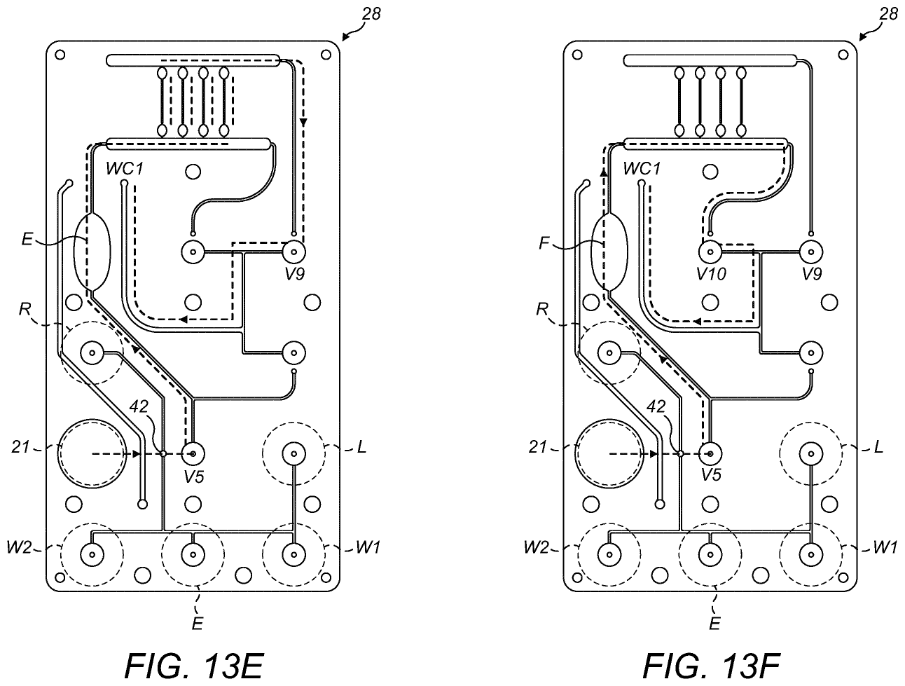

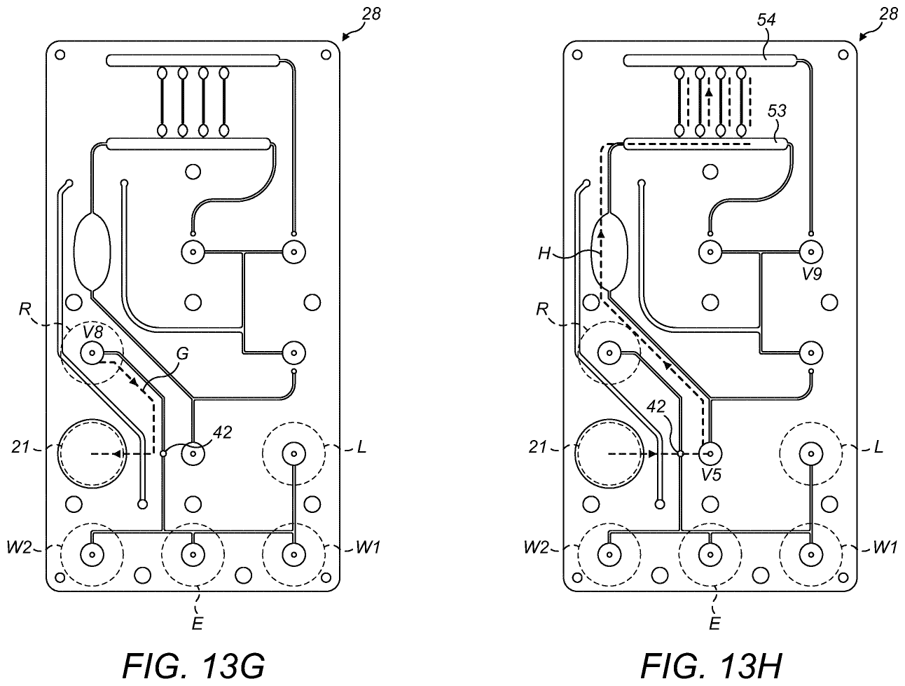

As shown with reference to FIG. 13A, the sample may be first transported from the loading chamber L to the extraction chamber 21. This may be achieved by opening valve V4 and operating the first pump to pull its pump piston up to create a negative pressure in the extraction chamber 21. Due to this the sample follows the flow path shown in FIG. 13A labelled with arrow A.

Next the magnetic actuator 10 of the instrument 2 may be activated to move the magnetic beads within the extraction chamber 21 to mix the sample, the lysis buffer and the magnetic beads. The mixing promotes lysis of the cells and/or particles of the sample allowing the nucleic acids to bind to the surface of the magnetic beads. In this step the magnetic actuator 10 may be actuated in its first mode in which the magnetic flux of the magnets engages the magnetic beads. The magnetic actuator 10 may then be rotated or spun in one rotational sense or rotated back-and-forth in both rotational senses to induce movement, e.g. a jumping movement, of the magnetic beads within the extraction chamber.

Next, and optionally, the mixture may be pushed back to the loading chamber L by reversing the movement of the piston, e.g. lowering the piston, of the first pump to positively pressurise the extraction chamber 21, and then the mixture may be pulled once again back to the extraction chamber 21 by pulling its pump piston up to create a negative pressure in the extraction chamber 21. The to-and-forth movement of the mixture may promote better lysis due to increased shear forces experienced by the mixture as it is transported. In addition the movement may increase the possibility of the nucleic acids binding with the surface of the magnetic beads. Optionally, some or all of the magnetic beads may move with the mixture out of the extraction chamber 21 towards the loading chamber L and back into the extraction chamber 21 during the to-and-forth movement of the mixture.

Preferably, the magnetic actuator 10 remains activated, for example in its first mode of operation, during the to-and-forth movement of the mixture to provide continual mixing of the mixture when in the extraction chamber 21.

Once the mixing step has been completed valve V4 may be closed and excess liquid in the extraction chamber 21 may be moved to the waste reservoir 23 as follows.

As shown with reference to FIG. 13B, excess liquid may be transported from the extraction chamber 21 to the waste reservoir 23. Rotation of the magnetic actuator 10 may first be switched off. Valves V5 and V6 may be opened. The first and/or second pump may be operated to positively pressurise the extraction chamber 21 to push the excess liquid to the waste reservoir 23 following the flow path shown in FIG. 13B labelled with arrow B. Then valves V5 and V6 may be closed.

Next the magnetic beads may be washed to remove dirt particles and lysis by-products from the extraction chamber 21.

The washing may be carried out in two stages. In a first stage wash buffer from the first wash chamber W1 is transported to the extraction chamber 21 as shown with reference to FIG. 13C. Valve V1 may be opened and the first pump operated to create a negative pressure in the extraction chamber 21 to pull the wash buffer into the extraction chamber 21 along the flow path shown in FIG. 13C labelled with arrow C. The magnetic actuator 10 of the instrument 2 may be activated in its first mode to move the magnetic beads within the extraction chamber 21 to wash the magnetic beads in the wash buffer. During this washing impurities may be detached from the nucleic acids bonded with the magnetic beads results in purer nucleic acids bound to the magnetic beads and the wash buffer containing the impurities. After the wash step is completed the valve V1 is closed and the wash buffer (and impurities) may be moved to the waste reservoir 23 using the same flow path and valve operations as described above. The nucleic acids remain safely bound with the silica beads in the extraction chamber 21.

A second wash stage may then be carried out using the wash buffer in the second wash chamber W2. This may be carried out as described for the first stage except with actuation of valve V3 that controls fluid flow out of the second wash chamber W2. As before, after the second wash step is completed the valve V3 is closed and the wash buffer (and impurities) may be moved to the waste reservoir 23 using the same flow path and valve operations as described above.

Next an elution step may be carried out. Elution is used to isolate or separate the nucleic acids from the magnetic beads. The pure nucleic acids attached to the magnetic beads must be separated for amplification and detection.

The first functional work done by the elution buffer when added to the extraction chamber is to remove all the ethanol from the magnetic beads. When all the ethanol is washed away from the magnetic beads, the elution buffer causes the release of e.g. total RNA and DNA from the magnetic beads. This secures the final production of purified RNA and DNA. The magnetic beads may also be surface treated to support only binding of DNA or only binding of RNA.

The elution may comprise two elution stages. In the first elution stage a first quantum of the elution buffer may be transported from the elution chamber E to the extraction chamber 21 and flushed through the extraction chamber 21 to waste to remove impurities from the extraction chamber 21. This may be achieved by opening valve V2 and operating the first pump to create a negative pressure in the extraction chamber 21 such that the elution buffer flows along the path shown in FIG. 13D labelled with arrow D. The first elution stage may use 250 μl of elution buffer at which point valve V2 may be closed and the elution buffer may then reside in the extraction chamber 21 for only a short time, for example for 15 seconds and is then pushed to the waste. This short period of exposure may allow the removal of impurities without disturbing the attachment of the nucleic acids to the magnetic beads. Removal of liquid to waste follows the procedure described above.

In the second elution stage a second quantum of the elution buffer may be transported from the elution chamber E to the extraction chamber 21 (again by opening and closing valve V2) and held for a retention period in the extraction chamber 21 to detach the nucleic acids from the magnetic beads to form an eluate containing the nucleic acids. The second elution stage may use 100 μl of the elution buffer. The elution buffer may be left to incubate in the extraction chamber 21 at, e.g. room temperature for a longer time period, for example for five minutes. During this stage, the nucleic acids may be detached from the magnetic beads' surface and are dissolved into the elution buffer to form the eluate.

A general channel drying procedure may be carried out between the first elution stage and the second elution stage to push out all the leftover reagents in the microchannels. The drying may be carried out by first opening valves V5 and V9. The pumps 7 may then be operated to increase the pressure in the extraction chamber 21. Fluid in the channels is thereby pushed to the waste reservoir 23 via the waste channel following the flow path shown in FIG. 13E labelled with arrow E

Thereafter valve V10 may be opened and valve V9 may be closed. The pumps 7 may create more pressure in the extraction chamber 21 such that fluid in the channels is pushed to the waste reservoir 23 via the first waste channel following the flow path shown in FIG. 13F labelled with arrow F.

During the elution stages the magnetic actuator 10 of the instrument 2 may be brought into closer proximity with the LOC 1, e.g. into its second mode of operation, to attract and hold the magnetic beads to a base of the extraction chamber 21 so that the magnetic beads cannot be moved out of the extraction chamber 21. The magnetic actuator 10 may preferably not be activated to rotate in this step such that the magnetic beads are held generally stationary. However, it is also important that the magnetic actuator 10 is able to then be moved away from the bottom part of the extraction chamber 21, into its first or third mode of operation as described above, in order to release the magnetic beads. This may allow the magnetic beads to be moved in and out of the extraction chamber 21 in order to further secure optimal lyses, washing or elution.

After the second elution stage reagent may be added to the extraction chamber 21 from the reagent chamber R. Valve V8 may be opened and the first pump operated to create a negative pressure in the extraction chamber 21 such that the reagent flows along the path shown in FIG. 13G labelled with arrow G. Valve V8 is then closed and the reagent and the eluate may be held in the extraction for an incubation period, for example of 2 minutes.

Next the mixture of the eluate and reagent may be moved to the reaction unit 22. Valves V5 and V9 may be opened and the first and/or second pump operated to create a positive pressure in the extraction chamber 21 to push the mixture to the first supply channel 53 along the path shown in FIG. 13H labelled with arrow H.

During this transport stage, the mixture may be pushed to flow through the quantification chamber 31 (that forms part of the flow path labelled H). The video camera 11, spectrophotometer microprobe, or other detector located under the chamber 31 of the instrument 2 may monitor the mixture's volume passed to the first supply channel 53 and/or the quantity of DNA or RNA present in the mixture. For example, spectrophotometric analysis may be used to determine the average concentrations of the nucleic acids DNA or RNA present in a mixture, as well as their purity. More particularly, in the case of DNA and RNA, a mixture may be exposed to radiation at a wavelength of 260 nanometres (nm) and a photo-detector may measure the light that passes through the mixture. Some of the radiation will pass through and some will be absorbed by the DNA/RNA. The more radiation absorbed by the mixture, the higher the nucleic acid concentration in the mixture. The resulting effect is that less radiation will strike the photodetector and this will produce a higher optical density (OD). As will be known to the skilled reader, the Beer-Lambert law may be used to relate the amount of radiation absorbed to the concentration of the absorbing molecule. Beneficially, the Beer-Lambert law may be used to determine unknown concentrations of nucleic acids without the need for standard curves.

A secondary benefit of using spectrophotometric analysis for nucleic acid quantitation is the ability to determine sample purity using a 260 nm:280 nm calculation. The ratio of the absorbance at 260 and 280 nm (A260/280) may be used to assess the purity of nucleic acids as will be known to the skilled reader.

The mixture may then enter the first set of reaction wells 50 and may be held there for a period of time. The mixture does not pass, at this stage, out of the reaction wells 50 into the microfluidic channels 52 due to the physical constriction in the outlet area of the reaction wells 50. At the constriction the surface tension of the mixture creates a force acting against passage of the mixture through the constriction. Once the reaction wells 50 are filled, the rest of the mixture may be moved to the waste reservoir 23 from the first supply channel 53 by opening valve V10.

The first set of reaction wells 50 may overly the first heater of the instrument 2 and may be heated to a set temperature of 65° C. This temperature may beneficially allow helicase enzymes to denature the nucleic acid strands and initiate isothermal amplification. The temperature may also help to open up the 3D structure of the packed pure nucleic acids extracted during the extraction step. At a temperature of 65° C., the primers may bind with their target.

The mixture may reside in the first set of reaction for a heating period of, for example, 2 to 5 minutes during which the first heater is energized to maintain the set temperature of 65° C. Thereafter the first heater may be switched off and a cooling period of, for example, 2 minutes initiated, so that the temperature of the mixture will not degrade the enzymes in the second set of reaction wells 51, e.g. T7 polymerase enzyme.

After incubation for approximately 2 minutes, the mixture in the first set of reaction wells 50 is moved to the second set of reaction wells 51 via the microfluidic channels 52 by applying additional positive pressure to the extraction chamber 21. At the end of the reactions wells 51 there are also constrictions of around 40 micrometer in size. These constrictions may ensure that nucleic acids in the mixture cannot pass out of the reaction wells 51 into the second supply channel 54. The mixture may be allowed to stay in the reaction wells 51 for up to 120 minutes or more.

The second set of reaction wells 51 may overly the second heater of the instrument 2 and may be heated to a set temperature of 41° C. This temperature may beneficially enable the NASBA enzymes to kickstart the amplification process.

The optical detector 6 then starts to read the data from the second set of reaction wells 51.

In an alternative mode of operation all of the reagent required for the amplification and detection of the nucleic acids may be contained in the reagent chamber and added to the eluate in the extraction chamber 21.

### Examples

The optical detector 6 of the LOC 1 can be used, for example, to detect up to four different targets in each reaction well 51. Thus, in total up to 32 targets can be identified using a single LOC 1 of the present disclosure.

For example, where the optical detector 6 is an ESE log optical reader, four different targets in a single reaction well can be detected by adding four different wavelengths of molecular beacons such that each target has a specific detection wavelength, for example 450 nm to 490 nm, 490 nm to 520 nm, 520 nm to 560 nm and 630 nm to 700 nm.

In one example test, two different targets were tested, a coliform target and a gram-negative target on an Escherichia bacteria, using a LOC 1 of the present disclosure. A comparative, parallel reaction was performed in a BioTek Synergy spectrophotometer to verify the process.

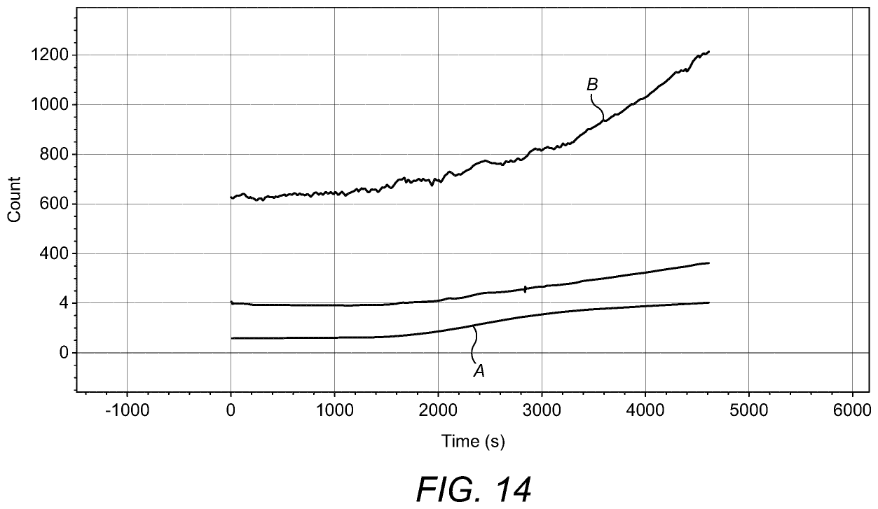

FIG. 14 shows the results from NASBA for the two targets where curve A represents the coliform target on the Escherichia bacteria and curve B represents the gram-negative target amplicons, which are detected at 450 nm to 490 nm.

The NASBA amplification can be observed, with the amplification starting after the 1600s mark. The coliform target shows a healthy amplification comparing the start and end points. Amplification of the gram-negative target was also clearly observable and was found to be significantly more detectable using the LOC 1 as compared to the spectrophotometer. For instance, the following table summarizes the results for the two targets for both the LOC 1 and the spectrophotometer:

| | Photons at | Photons at | |
|---|---|---|---|
| | 1800 s of | 4600s of | |
| Target and Device | amplification | amplification | Ratio |
| Coliform target on BioTek | 21000 | 85000 | 4.07 |
| Synergy spectrophotometer | | | |
| Coliform target on ESElog | 60 | 200 | 3.3 |
| detector reading LOC 1 | | | |
| Primer 68D Gram-Negative | 65000 | 75000 | 1.15 |
| target on BioTek Synergy | | | |
| spectrophotometer | | | |
| Primer 68D Gram-negative | 620 | 1200 | 1.935 |
| target on ESElog detector | | | |
| reading LOC 1 | | | |

The ratio in the above table show that the system of the present disclosure using the LOC 1 are comparatively good and reproducible. The 68D gram-negative target could not be identified in the BioTek synergy spectrophotometer, whereas a good amplification can be seen in the ESE log detector reading the LOC 1. This dual isothermal process demonstrates that the LOC 1 can perform various targets in an isothermal amplification.

Further aspects and embodiments of the present disclosure are set out in the following clauses:

Clause 1. A system for extracting and analysing cellular material, the system comprising an integrated lab-on-a-chip and an instrument;

the instrument comprising:
a) an interface for holding the integrated lab-on-a-chip;
b) one or more valve actuators or vacuum system for actuating one or more valves of the integrated lab-on-a-chip;
c) a detection unit for detecting an output of a reaction unit of the integrated lab-on-a-chip; and
d) one or more pumps;
   the integrated lab-on-a-chip comprising:
i) a loading chamber having an inlet for receiving a mixture comprising a sample containing cells and/or particles and a lysis buffer;
ii) an extraction chamber;
iii) a reaction unit; and
iv) one or more valves that control flow of fluid;
the loading chamber and the reaction unit being selectively enabled to be in fluid communication with the extraction chamber by actuation of the one or more valves of the integrated lab-on-a-chip as enabled by operation of the one or more valve actuators or vacuum system of the diagnostic instrument;
wherein the extraction chamber comprises or is connected to one or more gas ports that are configured to be placed in fluid communication with the one or more pumps of the instrument such that operation of the one of more pumps enables the generation of positive and negative pressures in the extraction chamber to enable pumping of fluid into and out of the extraction chamber.

Clause 2. The system of clause 1, wherein the one or more pumps comprise a positive pressure pump connected to a positive pressure port of the extraction chamber and a negative pressure pump connected to a negative pressure port of the extraction chamber.

Clause 3. The system of clause 1 or clause 2, wherein the one or more pumps are motor-operated, preferably stepper-motor operated.

Clause 4. The system of any preceding clause, wherein the extraction chamber has a volume for treating ≥0.75 millilitre, preferably ≥1.0 millilitre of the mixture.

Clause 5. The system of any preceding clause, wherein at least one of the gas ports is directly connected to the extraction chamber, preferably to a top side of the extraction chamber.

Clause 6. The system of any preceding clause, wherein at least one of the gas ports is indirectly connected to the extraction chamber, preferably via a microfluidic channel.

Clause 7. The system of any preceding clause, wherein the integrated lab-on-a-chip further comprises a waste reservoir, the waste reservoir being selectively enabled to be in fluid communication with the extraction chamber by actuation of the one or more valves of the integrated lab-on-a-chip.

Clause 8. The system of clause 7, wherein the integrated lab-on-a-chip further comprises a first waste microchannel and second waste microchannel for transporting liquid to the waste reservoir along at least two waste paths.

Clause 9. The system of clause 7 or clause 8, wherein the waste reservoir has a volume of ≥20 ml, preferably ≥30 ml.

Clause 10. The system of any preceding clause, wherein the extraction chamber comprises a plurality of beads, preferably magnetic beads.

Clause 11. The system of any preceding clause, wherein the instrument further comprises a magnetic actuator for moving magnetic beads in the extraction chamber.

Clause 12. The system of clause 11, wherein the magnetic actuator is movable to alter a separation distance between the magnetic actuator and the extraction chamber when the integrated lab-on-a-chip is held by the interface.

Clause 13. The system of clause 12, wherein the magnetic actuator is movable towards and away from the extraction chamber, along an axis that is perpendicular to a plane of the integrated lab-on-a-chip.

Clause 14. The system of any one of clauses 11 to 13, wherein the magnetic actuator is rotatable for inducing a jumping movement of the magnetic beads in the extraction chamber.

Clause 15. The system of any one of clauses 11 to 14, wherein the magnetic actuator comprises an array of magnets, and preferably the magnets are arranged in a cross-shaped array.

Clause 16. The system of any preceding clause, wherein the integrated lab-on-a-chip further comprises a wash chamber containing a wash buffer, the wash chamber being selectively enabled to be in fluid communication with the extraction chamber by actuation of the one or more valves of the integrated lab-on-a-chip.

Clause 17. The system of clause 16, further comprising a second wash chamber containing a second wash buffer, wherein the second wash chamber is selectively enabled to be in fluid communication with the extraction chamber by actuation of the one or more valves of the integrated lab-on-a-chip.

Clause 18. The system of any preceding clause, wherein the integrated lab-on-a-chip further comprises an elution chamber containing an elution buffer, the elution chamber being selectively enabled to be in fluid communication with the extraction chamber by actuation of the one or more valves of the integrated lab-on-a-chip.

Clause 19. The system of any preceding clause, wherein the integrated lab-on-a-chip further comprises a reagent chamber containing reagent that is selectively enabled to be in fluid communication with the extraction chamber by actuation of the one or more valves of the integrated lab-on-a-chip.

Clause 20. The system of clause 19, wherein the reaction unit contains additional reagent, preferably lyophilized reagent.

Clause 21. The system of any preceding clause, wherein the integrated lab-on-a-chip further comprises a conduit, preferably a microchannel, communicating between the extraction chamber and the reaction unit, and the conduit contains or passes through a quantification chamber configured to enable direct quantification of cellular material, for example nucleic acids, passing towards the reaction unit.

Clause 22. The system of clause 21, wherein the quantification chamber comprises a wall transmissive to radiation, preferably in the 260-280 nm range, and the instrument comprises a detector for detecting radiation emitted from the quantification chamber.

Clause 23. The system of any preceding clause, wherein the system is for extracting, amplifying and detecting nucleic acids.

Clause 24. The system of clause 23, wherein the reaction unit of the integrated lab-on-a-chip is a nucleic acid reaction unit, preferably a nucleic acid sequence amplification and detection unit.

Clause 25. An integrated lab-on-a-chip comprising:
i) a loading chamber having an inlet for receiving a mixture comprising a sample containing cells and/or particles and a lysis buffer;
ii) an extraction chamber;
iii) a reaction unit; and
iv) one or more valves that control flow of fluid;
the loading chamber and the reaction unit being selectively enabled to be in fluid communication with the extraction chamber by actuation of the one or more valves of the integrated lab-on-a-chip;
wherein the extraction chamber comprises or is connected to one or more gas ports that are configured to be placed in fluid communication with one or more external pumps such that operation of the one of more external pumps enables the generation of positive and negative pressures in the extraction chamber to enable pumping of fluid into and out of the extraction chamber.

Clause 26. The integrated lab-on-a-chip of clause 25, wherein the one or more gas ports comprise a negative pressure port and a positive pressure port.

Clause 27. The integrated lab-on-a-chip of clause 25 or clause 26, wherein at least one of the gas ports is directly connected to the extraction chamber, preferably to a top side of the extraction chamber.

Clause 28. The integrated lab-on-a-chip of any one of clauses 25 to 27, wherein at least one of the gas ports is indirectly connected to the extraction chamber, preferably via a microfluidic channel.

Clause 29. The integrated lab-on-a-chip of any one of clauses 25 to 28, wherein the extraction chamber has a volume for treating ≥0.75 millilitre, preferably ≥1.0 millilitre of the mixture.

Clause 30. The integrated lab-on-a-chip of any one of clauses 25 to 29, further comprising a waste reservoir, the waste reservoir being selectively enabled to be in fluid communication with the extraction chamber by actuation of the one or more valves of the integrated lab-on-a-chip.

Clause 31. The integrated lab-on-a-chip of clause 30, further comprising a first waste microchannel and second waste microchannel for transporting liquid to the waste reservoir along at least two waste paths.

Clause 32. The integrated lab-on-a-chip of clause 30 or clause 31, wherein the waste reservoir has a volume of ≥20 ml, preferably ≥30 ml.

Clause 33. The integrated lab-on-a-chip of any one of clauses 25 to 32, wherein the extraction chamber comprises a plurality of beads, preferably magnetic beads.

Clause 34. The integrated lab-on-a-chip of any one of clauses 25 to 33, further comprising a wash chamber containing a wash buffer, the wash chamber being selectively enabled to be in fluid communication with the extraction chamber by actuation of the one or more valves of the integrated lab-on-a-chip.

Clause 35. The integrated lab-on-a-chip of clause 34, further comprising a second wash chamber containing a second wash buffer, wherein the second wash chamber is selectively enabled to be in fluid communication with the extraction chamber by actuation of the one or more valves of the integrated lab-on-a-chip.

Clause 36. The integrated lab-on-a-chip of any one of clauses 25 to 35, further comprising an elution chamber containing an elution buffer, the elution chamber being selectively enabled to be in fluid communication with the extraction chamber by actuation of the one or more valves of the integrated lab-on-a-chip.

Clause 37. The integrated lab-on-a-chip of any one of clauses 25 to 36, wherein the integrated lab-on-a-chip further comprises a reagent chamber containing reagent that is selectively enabled to be in fluid communication with the extraction chamber by actuation of the one or more valves of the integrated lab-on-a-chip.

Clause 38. The integrated lab-on-a-chip of clause 37, wherein the reaction unit contains additional reagent, preferably lyophilized reagent.

Clause 39. The integrated lab-on-a-chip of any one of clauses 25 to 38, wherein the integrated lab-on-a-chip further comprises a conduit, preferably a microchannel, communicating between the extraction chamber and the reaction unit, and the conduit contains or passes through a quantification chamber configured to enable direct quantification of cellular material, preferably nucleic acids, passing towards the reaction unit.

Clause 40. The integrated lab-on-a-chip of clause 39, wherein the quantification chamber comprises a wall transmissive to radiation, preferably in the 260-280 nm range.

Clause 41. The integrated lab-on-a-chip of any one of clauses 25 to 40, wherein the reaction unit is a nucleic acid reaction unit, preferably a nucleic acid sequence amplification and detection unit.

Clause 42. The integrated lab-on-a-chip of any one of clauses 25 to 41, further comprising an outlet for supplying fluid containing extracted and purified and optionally amplified cellular material to an external device.

Clause 43. A method of extracting and analysing cellular material using an integrated lab-on-a-chip and a diagnostic instrument, the method comprising the steps of:
i) loading a mixture comprising a sample containing cells and/or particles and a lysis buffer into a loading chamber of the integrated lab-on-a-chip;
ii) transporting the mixture from the loading chamber to an extraction chamber of the integrated lab-on-a-chip;
iii) mixing the mixture in the extraction chamber using a plurality of beads to lyse the cells and/or particles of the sample and bind cellular material of the cells and/or particles to the beads;
iv) optionally transporting excess liquid from the extraction chamber to waste;
v) transporting a wash buffer from a wash chamber of the integrated lab-on-a-chip to the extraction chamber;
vi) washing the beads and their bound cellular material with the wash buffer in the extraction chamber;
vii) optionally transporting excess liquid from the extraction chamber to waste;
viii) transporting an elution buffer from an elution chamber of the integrated lab-on-a-chip to the extraction chamber;
ix) eluting the beads and their bound cellular material with the elusion buffer in the extraction chamber to detach the cellular material from the beads to form an eluate containing the cellular material; and
x) transporting the eluate to a reaction unit of the integrated lab-on-a-chip, optionally amplifying the cellular material in the reaction unit, and analysing the cellular material using the instrument;
wherein the transportation of fluid into and/or out of the extraction chamber is carried out by generating positive and negative pressures in the extraction chamber by use of one or more pumps that are in fluid communication with the extraction chamber.

Clause 44. The method of clause 43, wherein the cellular material is nucleic acids.

Clause 45. The method of clause 43 or clause 44, wherein the transportation of fluids into the extraction chamber is carried out by generating a negative pressure in the extraction chamber by use of one or more pumps and the transportation of fluids out of the extraction chamber is carried out by generating a positive pressure in the extraction chamber by use of one or more pumps.

Clause 46. The method of any one of clauses 43 to 45, wherein the sample is filtrated before the mixture is loaded into the loading chamber

Clause 47. The method of any one of clauses 43 to 46, wherein in step iii) the plurality of beads are magnetic and the mixing comprises moving an external magnet or array of magnets to move the magnetic beads in the extraction chamber.

Clause 48. The method of any one of clauses 43 to 47, further comprising as part of step iii), transporting the mixture from the extraction chamber back to the loading chamber and then back to the extraction chamber by generating positive and negative pressures in the extraction chamber.

Clause 49. The method of clause 48, wherein the beads in the extraction chamber are magnetic beads and are moved using the external magnet or array of magnets during transport of the mixture from the extraction chamber back to the loading chamber and then back to the extraction chamber.

Clause 50. The method of any one of clauses 43 to 49, wherein in step ix) during elution the beads are held to a base of the extraction chamber by an external magnet or array of magnets.

Clause 51. The method of any one of clauses 43 to 50, further comprising after step vii) transporting a second wash buffer from a wash chamber, preferably a second wash chamber, to the extraction chamber, and washing the beads and their bound cellular material with the second wash buffer in the extraction chamber, and transporting excess liquid from the extraction chamber to waste.

Clause 52. The method of any one of clauses 43 to 51, wherein steps viii) and ix) comprise two elution stages:
a first elution stage in which a first quantum of the elution buffer is transported from the elution chamber to the extraction chamber and flushed through the extraction chamber to waste to remove impurities from the extraction chamber; and
a second elution stage in which a second quantum of the elution buffer is transported from the elution chamber to the extraction chamber and held for a retention period in the extraction chamber to detach the cellular material from the beads to form an eluate containing the cellular material.

Clause 53. The method of any one of clauses 43 to 52, further comprising between steps ix) and x) transporting reagent from a reagent chamber of the integrated lab-on-a-chip to the extraction chamber for mixing with the eluate.

Clause 54. The method of clause 53, wherein in step x) additional reagent is mixed with the eluate in the reaction unit.

Clause 55. The method of any one of clauses 43 to 54, wherein step x) further comprises directly quantifying the cellular material, for example nucleic acids, as they are transported to the reaction unit, preferably by radiometric quantification.

Clause 56. An instrument for actuating an integrated lab-on-a-chip, the instrument comprising:
a) an interface for holding the integrated lab-on-a-chip;
b) one or more valve actuators or vacuum system for actuating one or more valves of the integrated lab-on-a-chip;
c) a detection unit for detecting an output of a reaction unit of the integrated lab-on-a-chip;
d) one or more pumps; and
e) a magnetic actuator for moving magnetic beads in an extraction chamber of the integrated lab-on-a-chip.

Clause 57. The instrument of clause 56, wherein the magnetic actuator is movable to alter a separation distance between the magnetic actuator and the extraction chamber when the integrated lab-on-a-chip is held by the interface.

Clause 58. The instrument of clause 57, wherein the magnetic actuator is movable towards and away from the extraction chamber, along an axis that is perpendicular to a plane of the integrated lab-on-a-chip.

Clause 59. The instrument of any one of clauses 56 to 58, wherein the magnetic actuator is rotatable for inducing a jumping movement of the magnetic beads in the extraction chamber.

Clause 60. The instrument of any one of clauses 56 to 59, wherein the magnetic actuator comprises an array of magnets, and preferably the magnets are arranged in a cross-shaped array.

1. A system for extracting and analysing cellular material, the system comprising an integrated lab-on-a-chip and an instrument;
the instrument comprising:
a) an interface for holding the integrated lab-on-a-chip;
b) one or more valve actuators or vacuum system for actuating one or more valves of the integrated lab-on-a-chip;
c) a detection unit for detecting an output of a reaction unit of the integrated lab-on-a-chip; and
d) one or more pumps;
the integrated lab-on-a-chip comprising:
i) a loading chamber having an inlet for receiving a mixture comprising a sample containing cells and/or particles and a lysis buffer;
ii) an extraction chamber;
iii) a reaction unit; and
iv) one or more valves that control flow of fluid;
the loading chamber and the reaction unit being selectively enabled to be in fluid communication with the extraction chamber by actuation of the one or more valves of the integrated lab-on-a-chip as enabled by operation of the one or more valve actuators or vacuum system of the diagnostic instrument;
wherein the extraction chamber comprises or is connected to one or more gas ports that are configured to be placed in fluid communication with the one or more pumps of the instrument such that operation of the one of more pumps enables the generation of positive and negative pressures in the extraction chamber to enable pumping of fluid into and out of the extraction chamber.

2. The system of claim 1, wherein the extraction chamber comprises a plurality of beads, preferably magnetic beads and the instrument further comprises a magnetic actuator for moving the magnetic beads in the extraction chamber.

3. The system of claim 2, wherein the magnetic actuator is movable to alter a separation distance between the magnetic actuator and the extraction chamber when the integrated lab-on-a-chip is held by the interface.

4. The system of claim 2, wherein the magnetic actuator is rotatable for inducing a jumping movement of the magnetic beads in the extraction chamber.

5. The system of claim 1, wherein the integrated lab-on-a-chip further comprises a conduit, preferably a microchannel, communicating between the extraction chamber and the reaction unit, and the conduit contains or passes through a quantification chamber configured to enable direct quantification of cellular material, for example nucleic acids, passing towards the reaction unit;
and optionally wherein the quantification chamber comprises a wall transmissive to radiation, preferably in the 260-280 nm range, and the instrument comprises a detector for detecting radiation emitted from the quantification chamber.

6. (canceled)

7. An integrated lab-on-a-chip comprising:
i) a loading chamber having an inlet for receiving a mixture comprising a sample containing cells and/or particles and a lysis buffer;
ii) an extraction chamber;
iii) a reaction unit; and
iv) one or more valves that control flow of fluid;
the loading chamber and the reaction unit being selectively enabled to be in fluid communication with the extraction chamber by actuation of the one or more valves of the integrated lab-on-a-chip;
wherein the extraction chamber comprises or is connected to one or more gas ports that are configured to be placed in fluid communication with one or more external pumps such that operation of the one of more external pumps enables the generation of positive and negative pressures in the extraction chamber to enable pumping of fluid into and out of the extraction chamber.

8. The integrated lab-on-a-chip of claim 7, wherein the extraction chamber has a volume for treating ≥0.75 millilitre, preferably ≥1.0 millilitre of the mixture.

9. The integrated lab-on-a-chip of claim 7, wherein the extraction chamber comprises a plurality of beads, preferably magnetic beads.

10. The integrated lab-on-a-chip of claim 7, further comprising a wash chamber containing a wash buffer, the wash chamber being selectively enabled to be in fluid communication with the extraction chamber by actuation of the one or more valves of the integrated lab-on-a-chip.

11. The integrated lab-on-a-chip of claim 7, further comprising an elution chamber containing an elution buffer, the elution chamber being selectively enabled to be in fluid communication with the extraction chamber by actuation of the one or more valves of the integrated lab-on-a-chip.

12. The integrated lab-on-a-chip of claim 7, wherein the integrated lab-on-a-chip further comprises a reagent chamber containing reagent that is selectively enabled to be in fluid communication with the extraction chamber by actuation of the one or more valves of the integrated lab-on-a-chip.

13. The integrated lab-on-a-chip of claim 7, wherein the integrated lab-on-a-chip further comprises a conduit, preferably a microchannel, communicating between the extraction chamber and the reaction unit, and the conduit contains or passes through a quantification chamber configured to enable direct quantification of cellular material, preferably nucleic acids, passing towards the reaction unit;
and optionally wherein the quantification chamber comprises a wall transmissive to radiation, preferably in the 260-280 nm range.

14-15. (canceled)

16. A method of extracting and analysing cellular material using an integrated lab-on-a-chip and a diagnostic instrument, the method comprising the steps of:
i) loading a mixture comprising a sample containing cells and/or particles and a lysis buffer into a loading chamber of the integrated lab-on-a-chip;
ii) transporting the mixture from the loading chamber to an extraction chamber of the integrated lab-on-a-chip;
iii) mixing the mixture in the extraction chamber using a plurality of beads to lyse the cells and/or particles of the sample and bind cellular material of the cells and/or particles to the beads;
iv) optionally transporting excess liquid from the extraction chamber to waste;
v) transporting a wash buffer from a wash chamber of the integrated lab-on-a-chip to the extraction chamber;
vi) washing the beads and their bound cellular material with the wash buffer in the extraction chamber;
vii) optionally transporting excess liquid from the extraction chamber to waste;
viii) transporting an elution buffer from an elution chamber of the integrated lab-on-a-chip to the extraction chamber;
ix) eluting the beads and their bound cellular material with the elusion buffer in the extraction chamber to detach the cellular material from the beads to form an eluate containing the cellular material; and
x) transporting the eluate to a reaction unit of the integrated lab-on-a-chip, optionally amplifying the cellular material in the reaction unit, and analysing the cellular material using the instrument;
wherein the transportation of fluid into and/or out of the extraction chamber is carried out by generating positive and negative pressures in the extraction chamber by use of one or more pumps that are in fluid communication with the extraction chamber.

17. The method of claim 16, wherein the transportation of fluids into the extraction chamber is carried out by generating a negative pressure in the extraction chamber by use of one or more pumps and the transportation of fluids out of the extraction chamber is carried out by generating a positive pressure in the extraction chamber by use of one or more pumps.

18. The method of claim 16, wherein in step iii) the plurality of beads are magnetic and the mixing comprises moving an external magnet or array of magnets to move the magnetic beads in the extraction chamber.

19. The method of claim 16, further comprising as part of step iii), transporting the mixture from the extraction chamber back to the loading chamber and then back to the extraction chamber by generating positive and negative pressures in the extraction chamber.

20. The method of claim 16, wherein step x) further comprises directly quantifying the cellular material, for example nucleic acids, as they are transported to the reaction unit, preferably by radiometric quantification.

21. An instrument for actuating an integrated lab-on-a-chip, the instrument comprising:
a) an interface for holding the integrated lab-on-a-chip;
b) one or more valve actuators or vacuum system for actuating one or more valves of the integrated lab-on-a-chip;
c) a detection unit for detecting an output of a reaction unit of the integrated lab-on-a-chip;
d) one or more pumps; and
e) a magnetic actuator for moving magnetic beads in an extraction chamber of the integrated lab-on-a-chip.

22. The instrument of claim 21, wherein the magnetic actuator is movable to alter a separation distance between the magnetic actuator and the extraction chamber when the integrated lab-on-a-chip is held by the interface;
and optionally wherein the magnetic actuator is movable towards and away from the extraction chamber, along an axis that is perpendicular to a plane of the integrated lab-on-a-chip.

23. (canceled)

24. The instrument of claim 21, wherein the magnetic actuator is rotatable for inducing a jumping movement of the magnetic beads in the extraction chamber.

25. (canceled)
